(19) United States
(12) Patent Application Publication
(10) Pub. No.: US 2017/0179564 A1
(43) Pub. Date: Jun. 22, 2017

(54) ELECTROMAGNETIC DIRECTIONAL COUPLER

(71) Applicant: Raytheon Company, Waltham, MA (US)

(72) Inventors: Anthony M. Petrucelli, Rancho Palos Verdes, CA (US); Laleh Rabieirad, Rancho Palos Verdes, CA (US); Samuel D. Tonomura, Rancho Palos Verdes, CA (US)

(21) Appl. No.: 14/970,851

(22) Filed: Dec. 16, 2015

(51) Int. Cl. H01P 5/18; H01P 11/00

(52) U.S. Cl. CPC H01P 5/184; H01P 11/003

(57) ABSTRACT

A directional coupler including input line has a first coupler portion that extends between an input port and transmitted port. The coupler also has an output line having a second coupler portion connected to an output port and that extends in a same direction as the first coupler portion and is directly above or below the first coupler portion and a substrate. The coupler also includes a metal ground plane disposed over the substrate and below the input and output lines, the metal ground plane including a patterned region disposed below first and second coupler portions and including cross members that extend in a direction perpendicular to the first and second coupler portions.

### BACKGROUND

The subject matter disclosed herein relates to couplers and, in particular, to an electromagnetic directional coupler.

FIG. 1 shows a top view of an example 100 and is presented to explain the general operation of the embodiments disclosed herein. The coupler 101 in which an input signal is coupled from an input line 104 to an output line 106. Both input and output lines 104,106 may be formed of any type of conductive material such as, for example, a wire or metallic trace. The body 102 of the coupler 101 can be formed of a silicon substrate onto which other elements/layers described below are formed over.

The input signal (shown by arrow 112) provided at an input port 110 is partially transmitted along input line 104 to a transmitted port 114. The transmitted signal received at the transmitted port 114 is shown by arrow 116.

A portion of the power received at the input port 110 may be coupled to an output (or coupled) port 120. The output port 120 may be directly connected by a metal connection to the isolated port 118 to form output line 106. In normal naming context, the input port 110 may be called port 1, transmitted port 114 may be called port 2, output port 120 may be called port 3, and isolated port 118 may be called port 4.

The power incident upon input port 110 is partially coupled to output port 120. The ratio of the power at the output port 120 (of signal shown by arrow 122) to the power at the input port 110 is referred to as the coupling ratio. If a lossless condition is assumed, then the signal splitting losses are 3 dB on both termination port 114 and output port 120. That is, the power of input signal 112 is split into two parts with the power at output port 120 and termination port 114 both being one half the power of the input signal. Of course, due to non-ideal impedance matching and dielectric losses the coupling factor may be below (worse than) 3 dB, but nevertheless power (signal) is coupled from input port 110 to the output port 120.

### BRIEF DESCRIPTION

Disclosed herein is a directional coupler including input line having a first coupler portion that extends between an input port and transmitted port is disclosed. The coupler also has an output line having a second coupler portion connected to an output port and that extends in a same direction as the first coupler portion and is directly above or below the first coupler portion and a substrate. The coupler also includes a metal ground plane disposed over the substrate and below the input and output lines, the metal ground plane including a patterned region disposed below first and second coupler portions and including cross members that extend in a direction perpendicular to the first and second coupler portions.

Also disclosed is a method of forming a directional coupler. The method includes: forming a substrate; forming a metal ground plane over the substrate, the metal ground plane including a patterned region including cross members that extend in a first direction; forming an input line having a first coupler portion that extends between an input port and transmitted port in a second direction; and forming an output line having a second coupler portion connected to an output port, the second coupler portion being above the first coupler portion and extending in the second direction. In this embodiment, the second direction is perpendicular to the first direction.

### BRIEF DESCRIPTION OF THE DRAWINGS

The following descriptions should not be considered limiting in any way. With reference to the accompanying drawings, like elements are numbered alike:

FIG. 1 is a top view of an example prior art directional coupler;

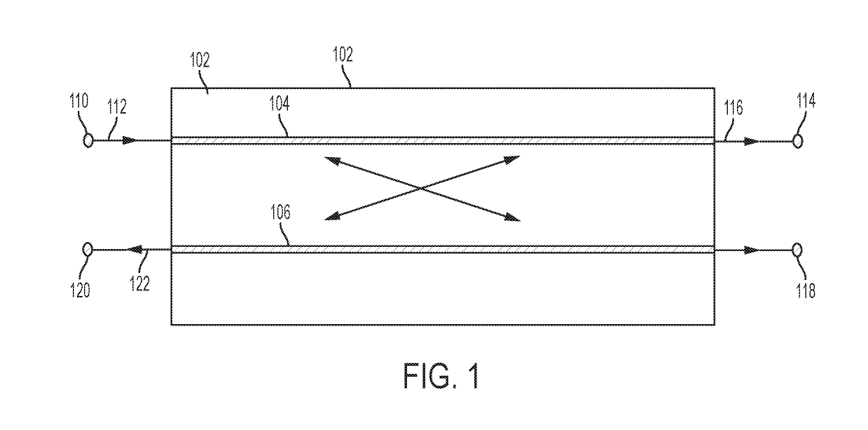

FIG. 2 is a perspective view of a directional coupler according to one embodiment;

FIG. 3 shows an exploded view of a portion of the directional coupler of FIG. 2;

FIG. 4 shows a cross-section of the directional coupler of FIG. 2; and

FIG. 5 shows a sub-set of the layers shown in FIG. 4 according to an alternative embodiment.

### DETAILED DESCRIPTION

A detailed description of one or more embodiments of the disclosed system, apparatus and method are presented herein by way of exemplification and not limitation with reference to the Figures.

One embodiment disclosed herein includes a radio frequency (RF) directional coupler formed of low-resistivity dielectric materials. The coupler includes a shielding metal ground plane that includes a patterned mesh formed therein and disposed between the coupler's coupling elements and the substrate that is below the coupling elements.

An example application of the directional coupler disclosed herein is a element of a reflective phase shifters. Such shifters are useful for wideband and low loss applications, and couplers are a necessary component in a reflective phase shifter. In some cases, directional couplers are formed on low resistivity substrates (e.g., SiGe CLC with Si substrate). In such cases it is important to reduce coupling between the input/output lines to the substrate to minimize loss. This often means shielding the input/outlines (which may be referred to simply as “coupler” herein) from the substrate using a metal shielding ground layer between the layers used to form the coupler and the Si substrate.

Current available SiGe processes consist of a Si substrate with multiple and alternating SiO₂ dielectric and metal routing layers that contain the coupling elements (e.g., the input and output lines described above) as well as a shielding or ground layer. However, the SiO2 layers are not thick, and thus it is not possible to create a structure where the shielding ground layer is far away from the coupling element layers. The result is significant coupling form the coupling elements to the shielding ground plane, reducing coupling between the desired coupled elements, and increasing coupler loss.

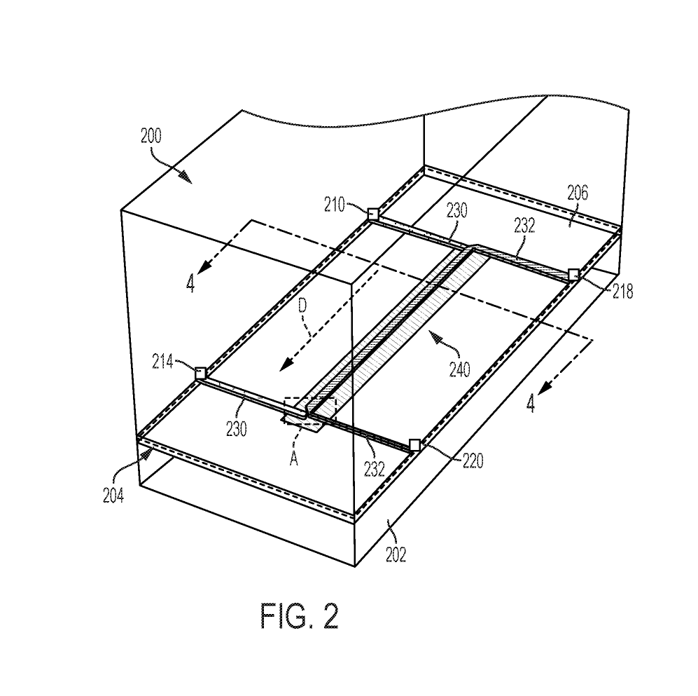

FIG. 2 shows a perspective view of one embodiment of an electromagnetic coupler 200 according to one embodiment. This depiction is simplified and does not show all of the alternating layers described above and more fully explained below. As such, one or more embodiments herein may have all of the elements shown in FIG. 2 but may also include additional elements and layers.

This embodiment includes a base substrate 202. The base substrate 202 may be formed of silicon in one embodiment. Of course, other low resistivity substrates may be used.

Disposed over the substrate 202 are one or more thin insulating layers that are generally referred to as by reference numeral 204. These insulating layers 204 may include one or more layers that includes a ground plane 206 formed of a metal disposed on a top layer or between layers. Ground plane 206 may include a patterned region 240 that is discussed below. The ground plane 206 may be sandwiched between two insulating layers 204 in one embodiment.

Metallic coupling elements 230 and 232 are at least partially formed over the ground plane 206 in a region over the patterned region 240. Herein, metallic coupling element 230 may be referred to as an input line and metallic coupling element 232 may be referred to as in output line. The portion of input and output lines that overlay one another (e.g., over the patterned region 240) are, respectively, referred to as first and second coupler portions. These coupler portions extend in the same direction in the region where they are “coupled” and that direction is shown by arrow D in FIG. 2.

The metallic coupling elements 230, 232 are physically separated from the ground plane 206 in one embodiment. That is, they may include one or more insulating layers 204 disposed between them and the ground plane 206. In one embodiment, the coupling elements 230, 232 are also separated from each other.

In operation, a signal on the input line 230 is coupled to an output line 232. Both input and output lines 230, 232 may be formed of any type of conductive material such as, for example, a wire or metallic trace. In one embodiment, the input and output lines 230, 232 are formed as traces carried by a dielectric layer such as one of the insulating layers 204.

An input signal is transmitted from an input port 210 along input line 230 to transmitted port 214. As above, a portion of the power received at the input port 210 may be coupled to an output (or coupled) port 218. The output port 218 is directly connected by output line 232 and isolated port 220 to form output line 232. Similar to the above, the input port 210 may be called port 1, transmitted port 214 may be called port 2, output port 218 may be called port 3, and isolated port 220 may be called port 4.

The power incident upon input port 210 is partially coupled to output port 218. The ratio of the power at the output port 218 to the power at the input port 210 is referred to as the coupling ratio.

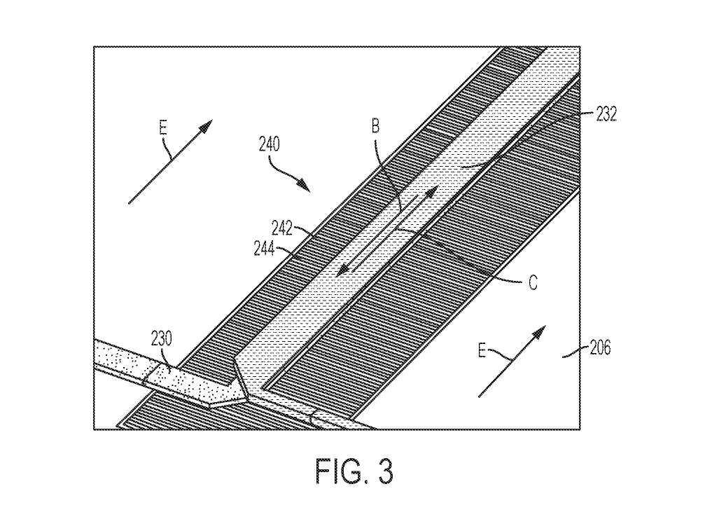

FIG. 3 shows an exploded view of region A in FIG. 2. The following discussion refers to both FIGS. 2 and 3. As illustrated, the insulating layers between the ground plane 206, input line 230 and output line 232 are omitted. As a signal travels from the input port 210 to output port 218 it travels along and in the direction shown by arrow B (note, arrow B is in substantially the same direction as arrow D of FIG. 2). This signal forms a return signal (e.g., current) that travels through the ground plane 206 directly below it and in the opposite direction as generally indicated by arrow C. These two signals may couple and, as such, lead to increased losses in the coupler 200.

According to one embodiment, the ground plane 206 includes patterned region 240. This region 240 serves to reduce the coupling between input line 230, output line 232 and the ground plane 206. In more detail, the patterned region 240 may reduce coupling to shielding ground plane 206 by patterning the ground plane (e.g, in region 240) directly below metallic coupling elements 230 and 232 using only the SiGe process. The patterned region 240 includes many thin and closely spaced cross members 242 that run perpendicular to metallic coupling elements 230 and 232. That is, they extend perpendicular to directions B and D described above. This eliminates or reduces return current directly below metallic coupling elements 230 and 232 (e.g., arrow C), forcing return current to flow in solid (un-patterned) ground plane 206 as indicated by arrow(s) E. This effectively makes dielectric between metallic coupling elements 230 and 232 and ground plane 206 look thicker, reducing undesired coupling to ground and, thereby (reduces loss). In one embodiment, the line widths of the metallic coupling elements 230 and 232 may be increased allowing for greater coupling and decreased loss. In one embodiment, the space 244 between the cross members 242 is filled with a dielectric material such as silicon dioxide.

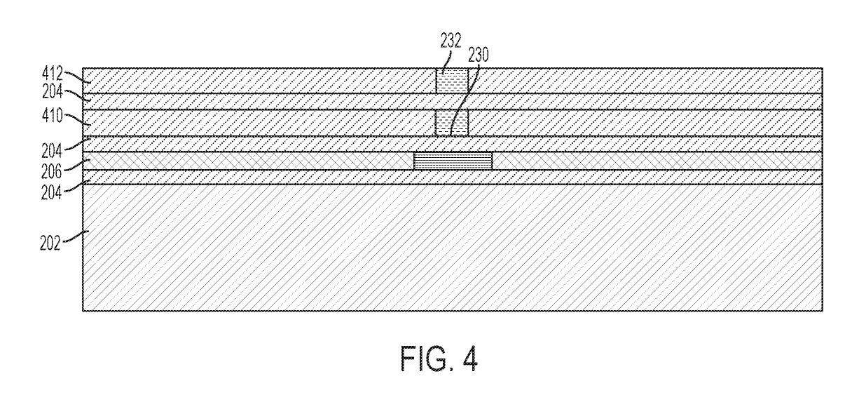

FIG. 4 shows a cross-section taken along line 4-4 of FIG. 2 and includes some of the insulating layers omitted in prior views. This embodiment includes a base substrate 202. The base substrate 202 may be formed of silicon in one embodiment. Of course, other low resistivity substrates may be used.

Disposed over the substrate 202 are one or more thin insulating layers that are generally referred to as by reference numeral 204. These insulating layers 204 may include one or more layers that includes a ground plane 206 formed of a metal interspersed between them. As illustrated, the ground plane 206 is sandwiched between two insulating layers 204. As discussed above, the ground plane 206 may include a patterned region 240. In FIG. 4, portions of the patterned region 240 are not visible as the cross-section is taken between on two of the cross members 242.

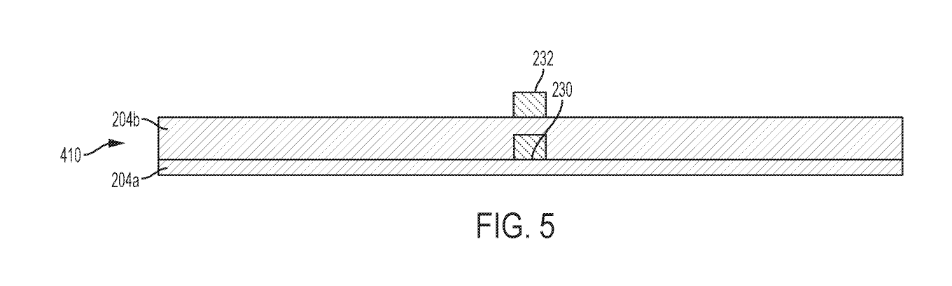

Metallic coupling elements 230 and 232 are at least partially formed over the ground plane 206 in a region over the patterned region 240. In one embodiment, the first metallic coupling element 230 is carried within by an insulating first coupler layer 410 and the second metallic coupling element 232 is carried within an insulating second coupler layer 412. The first and second coupler layers 410, 412 may be separated by another insulating layer 204 in one embodiment. Of course, variations in the layers may exist without departing from embodiments disclosed herein. For example, the coupler layers 410, 412 could be integrated into adjacent insulating layers 204. That is, in one embodiment, and as shown in FIG. 5, first insulating layer 204a could have a metallic coupling element 230 formed on an upper surface thereof. This combination of the first insulating layer 204a and the metallic coupling element 230 may then by overlaid by a second insulating layer 204b. Then metallic coupling element 232 can be formed on top of the second insulating layer 204b.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A directional coupler comprising:
an input line having a first coupler portion that extends between an input port and transmitted port;
an output line having a second coupler portion connected to an output port and that extends in a same direction as the first coupler portion and is directly above or below the first coupler portion;
a substrate; and
a metal ground plane disposed over the substrate and below the input and output lines, the metal ground plane including a patterned region disposed below first and second coupler portions and including cross members that extend in a direction perpendicular to the first and second coupler portions.

2. The directional coupler of claim 1, further comprising:
a first insulating layer disposed between the substrate and the metal ground plane.

3. The directional coupler of claim 2, wherein the substrate is formed of silicon and the first insulating layer is formed of silicon dioxide.

4. The directional coupler of claim 1, wherein the output line is coupled to a termination port at an opposite end than is connected to the output port.

5. The directional coupler of claim 1, wherein spaces exist between the cross members.

6. The directional coupler of claim 1, wherein the spaces are filled with silicon dioxide.

7. The directional coupler of claim 1, wherein the input and output lines are formed of metal traces.

8. The directional coupler of claim 1, wherein an insulating layer is disposed between first and second coupler portions.

9. A method of forming a directional coupler, the method comprising:
forming a substrate;
forming a metal ground plane over the substrate, the metal ground plane including a patterned region including cross members that extend in a first direction
forming an input line having a first coupler portion that extends between an input port and transmitted port in a second direction; and
forming an output line having a second coupler portion connected to an output port, the second coupler portion being above the first coupler portion and extending in the second direction;
wherein the second direction is perpendicular to the first direction.

10. The method of forming a directional coupler of claim 9, further comprising:
disposing a first insulating layer between the substrate and the metal ground plane.

11. The method of forming a directional coupler of claim 10, wherein the substrate is formed of silicon and the first insulating layer is formed of silicon dioxide.

12. The method of forming a directional coupler of claim 9, wherein the output line is coupled to a termination port at an opposite end than is connected to the output port.

13. The method of forming a directional coupler of claim 9, further comprising:
disposing an insulating layer between first and second coupler portions.
